(19) United States
(12) Patent Application Publication
(10) Pub. No.: US 2026/0244857 A1
(43) Pub. Date: Aug. 20, 2026

(54) IMPLEMENTING CONFIGURATION CHANGES USING LANGUAGE MODELS

(71) Applicant: Cisco Technology, Inc., San Jose, CA (US)

(72) Inventors: Prashanth Arun, San Jose, CA (US); Ehsan Aghaei, Charlotte, NC (US)

(21) Appl. No.: 19/082,060

(22) Filed: Mar. 17, 2025

Related U.S. Application Data
(60) Provisional application No. 63/761,116, filed on Feb. 20, 2025.

(51) Int. Cl. G06F 40/263; H04L 41/16

(52) U.S. Cl. CPC G06F 40/263; H04L 41/16

(57) ABSTRACT

Techniques for providing a language model to understand and recommend product configuration changes, corresponding to specific requirements are described. A language model is deployed to a network controller and is configured to respond to inputs from network administrators. The language model receives an input from the network administrator indicating a description of a requirement for a configuration change. The language model determines a series of actions to execute to implement the configuration change. Finally, the language model outputs the series of actions to execute to the network administrator.

### RELATED APPLICATIONS

This application claims priority to U.S. Provisional Patent Application No. 63/761,116 filed on Feb. 20, 2025, the entire contents of which are incorporated herein by reference and for all purposes.

### TECHNICAL FIELD

The present disclosure relates generally to provisioning language models to understand and recommend product configuration changes, corresponding to specific requirements.

### BACKGROUND

Computer networks, or groups of connected computers or other devices that use communication protocols to exchange data, have continued to become more complex. As network complexity continues to increase, managing and updating configurations for networking devices for security reasons, or other enterprise organization policy changes in a production environment is complex due to the high volume of devices, varying configuration requirements, and the need for stringent security compliance. Ensuring consistency across diverse systems requires meticulous planning and can lead to significant downtime or vulnerabilities if not handed correctly. This complexity is compounded by frequent updates and evolving security policies. Thus, the management of network configurations requires meticulous manual effort by networking personnel and demands constant vigilance and precision.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a language model deployed to a network controller determine actions to execute to implement a configuration change requirement.

FIG. 2 illustrates an example environment for utilizing multiple language models to output a series of optimal actions to implement a required configuration change to a network administrator.

FIG. 3 illustrates an example process flow for utilizing multiple language models to output a series of optimal actions to implement a required configuration change to a network administrator.

FIG. 4 illustrates a flow diagram of an example method using a language model to determine actions to execute to implement a configuration change requirement.

FIG. 5 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to provisioning language models in a detect and response system to automate the identification, containment, eradication, and recovery of a security incident. A language model uses function calling to determine that a potential security incident is a true positive, and determining how to respond to the security incident, document the security incident, contain the security incident, and finally eradicate the security incident.

A method described herein may include deploying a language model to a network controller that is configured to respond to inputs from network administrators associated with the network. Additionally, the method may include receiving, by the language model, an input from a network administrator indicating a description of a requirement for a configuration change. The method may also include determining, by the language model, a series of actions to execute to implement the configuration change. Finally, the method may include outputting, by the language model, the series of actions to execute to the network administrator.

In some examples the language model is trained on network documentation and verbiage. In various embodiments, the language model is a first language model that determines a series of subtasks for the configuration change, inputs each subtask into a second language model, and receives an action to execute for each subtask from the second language model. In some embodiments the second language model is fine-tuned with datasets that include one or more actions to execute for a description of network configuration change. In some instances, each subtask in input into the second language model multiple times and the second language model generates multiple possible actions to execute to implement the subtask. The second language model may also evaluate each action of the multiple possible actions and determine an optimal action to execute from the multiple possible actions. In some examples, the optimal action is customizable and further based at least in part on policy requirements of an organization. In some examples, a language model is a large langue model (LLM).

Additionally, the techniques of at least the first method and the second method and any other techniques described herein, may be performed by a system and/or device having non-transitory computer-readable media storing computer-executable instructions that, when executed by one or more processors, performs the method(s) described above.

### EXAMPLE EMBODIMENTS

As described above, conventional management and configuration updating in a production network environment involves meticulous planning and manual effort by networking personnel to ensure consistency across diverse systems and minimal downtime.

Various types of virtual agents have emerged over the years with the purposes of interacting with and providing assistance to users as though they are human assistants. One type of virtual agent, known as a chatbot, is a computer program that has conversations with users through text or speech. Traditionally, chatbots operated under rule-based systems where rules and decision trees were used to recognize specific words or phrases provided by users, and provide predefined responses to the users based on these words or phrases. However, these chatbots were fairly limited and had difficulties handling unexpected or complex queries from users. Thus, while rule-based chatbots could handle basic tasks, these chatbots had fairly limited usefulness and provided little value for users.

More recently, there have been advances in AI that have enabled chatbots and other AI systems to perform complex tasks that normally require human intelligence. Generative AI is a type of artificial intelligence where models are used to create (or “generate”) new content based on inputs, often in the form of inputs from users. One type of generative AI model is particularly effective at generating text, specifically, the language model (e.g., the large language model (LLM)). Language models are trained on large sets or corpuses of text data to perceive and infer context from user queries, understand a broader range of queries, and generate human-like textual responses to the queries. Chatbots that are backed by language models are becoming increasingly popular among users due to their ability to perform complex tasks on behalf of users.

This disclosure describes techniques that provide for a customizable, AI-driven platform for recommending product configuration changes corresponding to specific requirements. Generative AI models are used for translating configuration change and configuration modification requirements into specific actionable configuration statement. The techniques described herein provide for an automated process for taking a broad configuration change and breaking it down into smaller configuration change steps. Each smaller configuration change step is then analyzed to determine a specific action to take that will implement the relatively small configuration change. As more than one action may be taken to accomplish each relatively small configuration change, all possible actions may be evaluated to determine an optimal series of actions to execute that will accomplish the broad high level configuration change. This process can be automated with generative AI, and either automatically implemented, or output to a network administrator to approve and/or carry out the actionable steps. Thus, conventional systems that require manual configuration changes may be automated or partially automated by providing an AI-based assistant that can analyze configuration change requirements and recommend specific actionable steps to enable required configuration changes to maintain security and availability. Language models may be utilized according to the techniques described herein to replace (or augment) and assist network administrators (also referred to as “network operators” herein) in determining and implementing actionable steps for a network configuration change necessary based on specific requirements according to an enterprise organization.

A network administrator may login to a console and once authenticated, may have a view of a network topology, including a configuration and operational metrics of all devices (hardware and software) deployed in the network. The network administrator may input a text description of a change requirement and receive a series of actionable steps needed to accomplish the overall change. In some examples, the network administrator may be inputed for approval to execute one or more steps to accomplish the change. In other instances, the changes may automatically be executed depending on the extent of the change, and/or according to policies of an enterprise organizations. On the backend, the change description input by the network administrator may be input to language model (e.g., a large language model (LLM)) that breaks the high level change requirement down into subtasks. These subtasks may then be input into a second language model that determines one or more possible specific small executable actions that may be taken to accomplish each subtask. Each possible executable action for each subtask may be input back into the second language model (or a third generative AI model) for evaluation. The second language model may then output an optimal series of steps to accomplish the overall change to the network administrator. It should be noted that one or many generative AI models may be used to implement the techniques described here. The examples described herein that include a first language model and a second language model may be accomplished with any number of language models or other generative AI model.

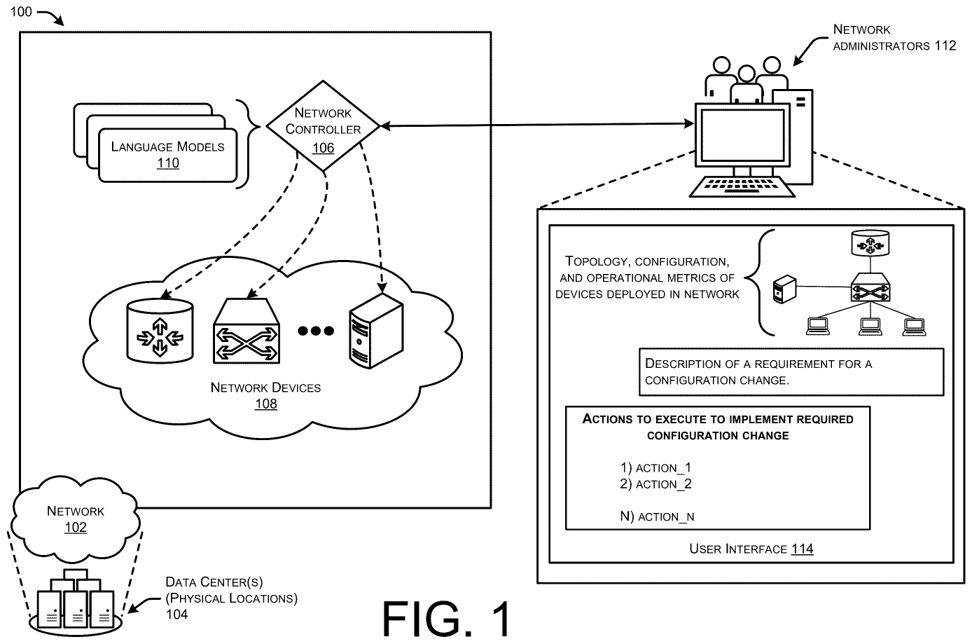

FIG. 1 illustrates a system-architecture diagram of an environment 100 in which language models deployed to a network controller determine actions to execute to implement a configuration change requirement.

The environment 100 may include a network 102 implemented by any viable communication technology, such as wired and/or wireless modalities and/or technologies. The network 102 may be any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed-and/or any combination, permutation, and/or aggregation thereof. The network 102 may include devices, virtual resources, or other nodes that relay packets from one network segment to another by nodes in the computer network. The network 102 may include multiple devices that utilize the network layer (and/or session layer, transport layer, etc.) in the OSI model for packet forwarding, and/or other layers. The network 102 may include various network devices 108, such as routers, switches, gateways, firewalls, smart NICs, NICs, ASICs, FPGAs, servers, and/or any other type of device. Further, the network 102 may include virtual resources, such as VMs, containers, and/or other virtual resources. However, the network 102 may be of a different type of architecture, such as a WAN, IoT network, cellular network, or any other type of network.

The one or more data centers 104 may be physical facilities or buildings located across geographic areas that are designated to store networked devices that are part of the network 102. The data centers 104 may include various networking devices, such as network devices 108, as well as redundant or backup components and infrastructure for power supply, data communications connections, environmental controls, and various security devices. In some examples, the data centers 104 may include one or more virtual data centers which are a pool or collection of cloud infrastructure resources specifically designed for enterprise needs, and/or for cloud-based service provider needs. Generally, the data centers 104 (physical and/or virtual) may provide basic resources such as processor (CPU), memory (RAM), storage (disk), and networking (bandwidth). However, in some examples the devices may not be located in explicitly defined data centers 104, but may be located in other locations or buildings.

The network controller 106 may perform various techniques for managing the network 102 and the network devices 108 therein. For instance, the network controller 106 may manage network behavior and policies, network configuration and provisioning, traffic engineering and optimization, policy enforcement, visibility and monitoring, and other network management operations. In some examples, network administrators 112 work with the network controller 106 to ensure that their network 102 is exhibiting desired characteristics, such as enforcing desired policies, implementing desired device configurations, or managing access to devices. Although a network controller is described herein, other types of controller may also be used to implement the techniques described herein, such as a systems controller and the like.

Environment 100 also include one or more language models 110. The language models may be large language mode (LLMs) or any other appropriate type of language model. In some instances, although not illustrated, environment 100 may include other appropriate gernative0AI models in addition to the language models 110. A network administrator(s) 112 may connect with the network controller 106 via one or more user interfaces 114 and once authenticated, the network administrator 112 can interact with the language models 110 via the user interface 114 to issue inputs and commands for initiating network configuration changes due to specific requirements. The interfaces 114 may be web-based portals, application interfaces, websites, CLIs, APIs, and/or any other interface through which data may be communicated. According to the techniques described herein, the user interface(s) 114 may receive inputs or other data from the network administrators 112 via text interfaces or other interactable elements as shown, thus, providing automated configuration changes customizable based on the policies and procedures of an enterprise organization.

Environment 100 illustrates an example user interface 114 in which, a network administrator 112 may login, and once authenticated, the network administrator may have a view of network information that includes a network topology, network configuration details, and operations metrics of device deployed in the network 102, such as network device 108. The example user interface 114 provides a text box for the network administrator 112 to type in a description of a requirement for a configuration change. For example, the network administrator 112 may have a change ticket and the network administrator may type in the description of the required change into the text box as illustrated. The user interface 114 may also include provisioning for the network administrator 112 to receive a response from the system that indicates actions to execute to implement the required configuration change the network administrator 112 entered. As illustrated in example environment 100, the network administrator 112 receives a series of action 1-N to implement the configuration change necessary due to the requirement change. It should be understood that the interface 114 is an example and not meant to be limiting. It may display any number of interactable elements such as selectable buttons, text boxes, pull down menus, and the like.

There have been advances in artificial intelligence (AI) that have enabled chatbots and other AI systems to perform complex tasks that normally require human intelligence, such as perceiving, synthesizing, and inferring information. Generally speaking, AI systems and models ingest large amounts of data (or “training data”), analyze this data to identify correlations and patterns, and use these patterns to make predictions about future states. Although AI programs and algorithms have been around for decades, the amount of data and computing power needed to train AI models that are useful for humans has not existed. However, there have been various technological breakthroughs and advances that have accelerated the usefulness of AI, such as advent of cloud computing that provides effectively unlimited compute, advances in specialized hardware (e.g., graphics processing units (GPUs)) that efficiently train and run these AI models, and the discovery of more efficient training algorithms.

Generative AI is a type of artificial intelligence where models are used to create (or “generate”) new content based on inputs, often in the form of inputs from users. One type of generative AI model is particularly effective at generating text, specifically, the large language model (LLM). Language models 110 are trained on large sets or corpuses of text data to perceive and infer context from user queries, understand a broader range of queries, and generate human-like textual responses to the queries and determine appropriate function to call to acquire needed information. Chatbots that are backed by language models 110 are becoming increasingly popular among users due to their ability to perform complex tasks on behalf of users.

One type of neural network architecture that has gained popularity due to its ability to reduce the amount of time needed to train generative AI models is known as the Transformer model, or simply “Transformers.” Transformers apply a set of mathematical techniques, called attention or self-attention, to capture relationships in sequential data called tokens, such as words in a sentence. Transformers are able to detect subtle causal relationships between data elements in a series, including how even distant data elements influence and depend on each other. Unlike previous models that have to process tokens sequentially (e.g., Recurrent Neural Networks (RNNs)), transformers use an attention mechanism to process tokens simultaneously and calculate the attention weights, or strengths of relationships, between the tokens in successive layers. Because transformers can compute attention weights for all the tokens in parallel, the amount of time needed to train generative AI models using transformers is greatly improved over other training models.

Generative AI can be used to generate text that resembles human-like responses to inputs. Transformers are very effective in training the models used generate text, often referred to as language models 110. Language models 110 are trained on large sets or corpuses of text data to generate human-like textual responses to inputs. Language models 110 are generally trained in two stages, pre-training and fine-tuning. During the pre-training stage, language models 110 are trained on massive datasets of unlabeled text data (or “unsupervised learning”) where transformers allow the language models 110 to process and learn the patterns and relationships between words. During the fine-tuning stage, the language models 110 can be fine-tuned for specific tasks or inputs, such as summarizing content, answering questions, and text completion. There are generalized language models 110 that have been trained on sets of text data describing all types of content (e.g., data obtained from crawlers that scrape the public Internet). There are also specialized language models 110 that have been trained on specialized sets of data that are specific to a particular type of content, such as networking technology.

The language models 110 may simply be off-the-shelf language models that is deployed to the network controller 106, but in other examples, the language models 110 may be pre-trained on networking documentation and verbiage. In some instances, the language models 110 may be fine-tuned for with datasets that include one or more actions to execute for a description of a network configuration change. In still other examples, language models 110 may be trained to evaluate an optimal series of executable action to take to implement a required configuration change based on a specific network.

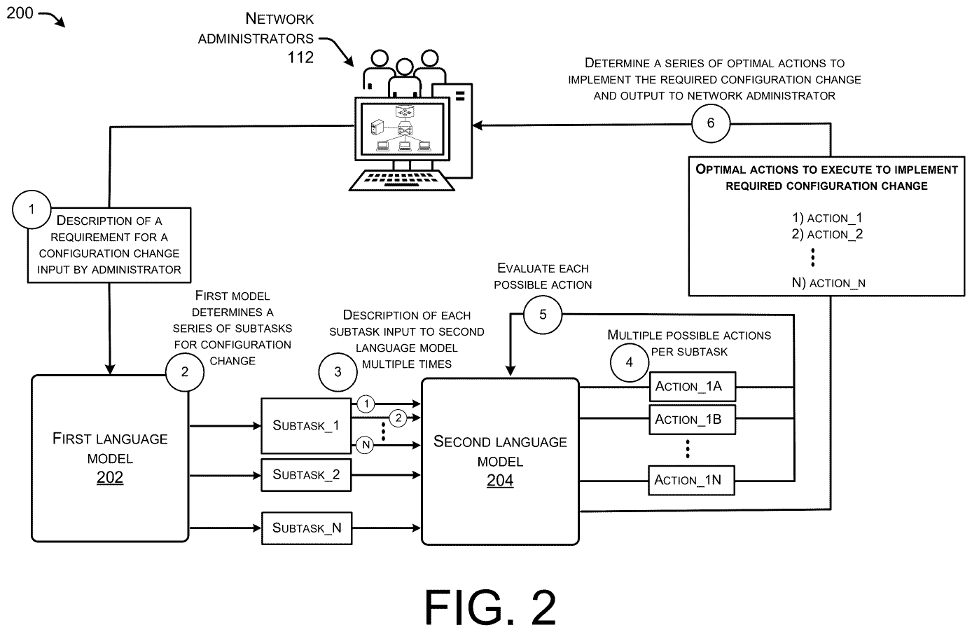

FIG. 2 illustrates an example environment 200 for utilizing multiple language models to output a series of optimal actions to implement a required configuration change to a network administrator.

In environment 200, at (1) a network administrator 112 may log into a network device that enables the network administrator 112 to interact with one or more language models via a user interface to issue inputs and commands for initiating network configuration changes due to specific requirements. For example, if an enterprise organization initiates a security policy change or the like, the network administrator can type in a description of the security policy change requirement into the user interface. For example, with reference to FIG. 1, the network administrator 112 types in a description of a requirement for a configuration change into the user interface 114 as illustrated.

At (2) a first language model 202 receives the description of the requirement change as entered by the network administrator 112. The first language model 202 determines a series of subtasks for implementing the configuration change. For example, the first language model 202 may be pretrained on network documentation and verbiage to enable the first language model 202 to take a broad high level description of a change requirement and break it down into small incremental subtask. First language model 202 may be one of the language model(s) 110 as illustrated and described with reference to FIG. 1.

At (3) each subtask determined by the first language model 202 in step (2) may be input into a second language model 204. The second language model 204 may determine an action to take to accomplish a subtask. In other words, a subtask may be a relatively simple or incremental required configuration change and the second language model 204 determines a command or step necessary to implement the incremental change. Thus, the second language model 204 may be fine-tuned on datasets that include one or more actions that can be executed to implement an incremental network configuration change. There may be multiple possible actions that can accomplish each subtask. Thus, in some instances, each subtask may be input to the second language model 204 multiple time. Illustrated in example environment 200, subtask_1 is input into the second language model 204 N times. Although not illustrated in example environment 100, each subtask 1-N may be input into the second language model 204 N times. Similar to the first language model 202 as described above, second language model 204 may be one of the language model(s) 110 as illustrated and described with reference to FIG. 1.

At (4) the second language model 204 outputs an action to execute to accomplish each subtask. As illustrated in example environment 200, subtask_1 is input into the second language model 204 N time, thus the second language model 204 outputs N actions that may be used to execute that will implement subtask_1, action_1A, action_1B, through action_1N. It should be noted that actions 1A-1N may not all be different action, some or all of the actions may be the same or similar. Although not illustrated, the same process may be used for each subtask.

At (5) the multiple possible actions for each subtask may be input back into second language model 204 and second language model 204 may evaluate each possible action to determine which action(s) are optimal for a particular network. Alternately or in addition, in some implementations the multiple possible actions to execute for each subtask may be input into a separate third language model for evaluation or other generative AI model to determine which actions(s) are optimal for a particular network.

At (6) the second language model 204 (or in some instances a third language model or other generative AI model) outputs a series of optimal actions to execute to implement the required configuration change to the network administrator 112. Alternately, the second language model 204 outputs the optimal actions to execute to implement the required configuration change to the first language model 202. In this example, the first language model 202 then outputs the series of optimal actions to execute to implement the required configuration change to the network administrator 112 via the interface, for example interface 114 as described with reference to FIG. 1. Alternately or in addition, in some implementations, the actions may automatically be executed, or the network administrator 112 may be inputed for approval of one or more actions prior to the actions being executed.

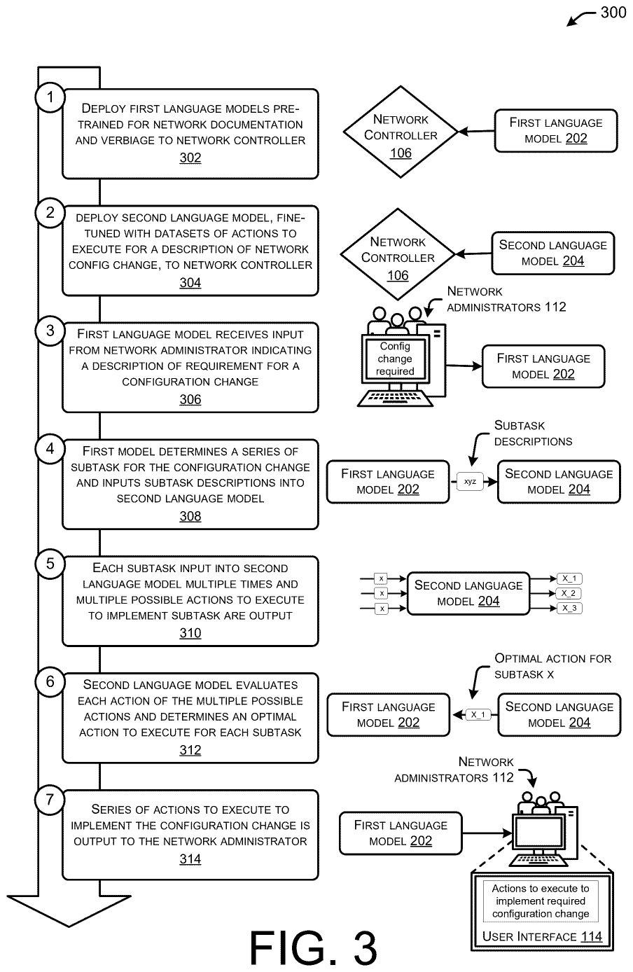

FIG. 3 illustrates a flow diagram 300 of an example method for using language models to recommend product configuration changes corresponding to specific enterprise organization requirements.

At 302, a first language model 202 may be deployed to a network controller 106. In some examples the first language model 202 may be pretrained on network specific documentation and verbiage. The first language model 202 may be pretrained for networks in general or for an enterprise organizations network in particular. With reference to FIG. 1 a first language model may be a language model 110 deployed to the network controller 106. In some examples the network controller 106 may communicate with remote computing resources that generate language models to train the first language model 202. The remote computing resources may be a cloud computing platform, an on-premises computing resource, or other available computing resources. In other instances, however, the network controller 106 itself may generate the language model 202.

At 304, a second language model 204 may be deployed to the network controller 106. In some examples the second language model may be fine-tuned on datasets that include one or more actions that can be executed to implement an incremental network configuration change. The similar to the first language model 202, the second language model 204 may be fine-tuned for networks in general or for an enterprise organizations network in particular. For example, with reference to FIG. 1 a second language model may be a language model 110 deployed to the network controller 106. Similar to the first language model 202, the network controller 106 may communicate with remote computing resources that generate language models to train the second language model 202. In other instances, however, the network controller 106 itself may generate the language model 202.

At 306, the first language model 202 receives an input from a network administrator indicating a description of a requirement for a configuration change. For example, with reference to FIG. 1 a network administrator 112 may input a description of a requirement for a configuration change into a user interface 114 as illustrated. The requirement for a configuration change may be in response to a change ticket resulting from an enterprise organization policy change, security update, or for any reason that makes a configuration change necessary.

At 308, the first language model 202 determines a series of subtasks for the configuration change and inputs the series of subtask descriptions into the second language model 204. Because the first language model 202 is pretrained on network documentation and verbiage, the first language model 202 can take a broad high level description of a change requirement, as entered by the network administrator in step 308, and break it down into small incremental subtask. Each subtask is then input into the second language model 204 one or more times.

At 310, each subtask determined by the first language model 202 may be input into the second language model 204 multiple times and multiple possible actions to execute to implement the subtask are output by the second language model 204. Because there may be more than one way to implement a configuration change requirement, each subtask may be input into the second language model 204 multiple times. As illustrated in step 310, the subtask ‘x’ is input into the second language model 204 three times resulting in three different actions that may be executed to implement subtask ‘x’. This example is not meant to be limiting and each subtask may be input into the second language model 204 more or less times. In addition, the possible actions to take may a single action or multiple actions. Furthermore, although only one subtask is illustrated as being input into the second language model 204, it should be understood to those skilled in the art that each subtask determined in step 308 may be input into the second model 204 one or more times to determine one or more actions that may implement the subtask when executed.

At 312, the second language model 204 evaluates each action of the multiple possible actions and determines an optimal action to execute for each subtask. The second language model 204 may outputs the optimal action for each subtask back to the first language model 202. Alternately or in addition, each of the multiple possible actions that when executed will enable the implementation of the subtask may be input into a third generative AI model for evaluation and the third language model may determine an optimal series of actions to execute to implement the configuration change requirement. The second language model 204 (or a third generative AI model) may be fine-tuned for evaluating the multiple possible executable actions for each subtask to determine an overall optimal series of executable actions to accomplish the required configuration change.

At 314, the first language model 202 outputs the optimal series of actions to execute to implement the configuration change to the network administrator 112 via the interface 114. Alternately or in addition, the first language model 202 may initiate automatic implementation of the series of actions to execute to implement the configuration change. Furthermore, in some instances, the first language model 202 may input the network administrator 112 for approval prior to initiating an action or the series of actions that will enable the configuration change.

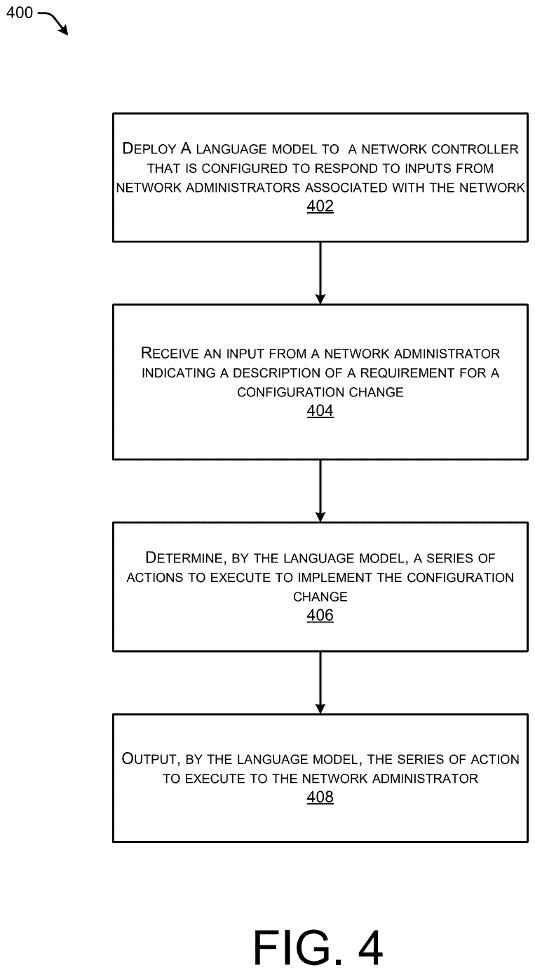

FIG. 4 illustrates a flow diagrams of an example method 400 that illustrates aspect of the functions performed at least partly by the devices described in FIGS. 1-3, such as the language models 110, first language model 202, and second language model 204. The logical operations described herein with respect to FIG. 4 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 400 may be performed by a device and/or a system of devices that includes one or more processors and one or more non-transitory computer-readable media storing computer-executable instructions that, when executed by the one or more processors, cause the one or more processors to perform operations of method 400.

At operation 402, a language model is deployed to a network controller. The language model is configured to respond to inputs from network administrators associated with a network. For example, with reference to FIG. 1, the language models 110 are deployed to the network controller 106. With reference to FIG. 3, at 302 a first language model 202 pre-trained using network documentation and verbiage is deployed to the network controller 106, and at 302 a second language model 204, fine-tuned with datasets of actions to execute for a descriptions of an incremental network configuration changes, is deployed to the network controller 106.

At operation 404, the language model receives an input from a network administrator indicating a description of a requirement for a configuration change. For example, with reference to FIG. 1 the interface 114 illustrates the text input from the network administrator 112 in the text box “description of a requirement for a configuration change.” As an example, if a network administrator has a change ticket resulting from a change in policy of an enterprise organization, a security update, etc., the network administrator types in the description of the change in the interface 114.

At operation 406, the language model determines a series of actions to execute to implement the configuration change. For example, with reference to FIG. 1, language model(s) 110 deployed to network controller 106 may determine a series of action to execute to implement the required configuration change. As illustrated in interface 114, actions 1-N have been determined as the series of actions to execute to implement the configuration change. With reference to FIG. 2, the first language model 202 receives the description of the requirement for a configuration change input by the network administrator 112 at (1), breaks the high level configuration change requirement description down into smaller incremental subtasks at (2), and outputs a description of each subtask to a second language model 204 at (3). Each subtask may be input to the second language model 204 multiple times to for evaluation. Thus, at (4) the second language model 204 determines multiple possible actions that, when executed, will implement each subtask. Finally, at (5) the second language model 204 (or in some instances a third generative-AI model) evaluates each possible action determined at (4) to determine a series of optimal actions to implement the required configuration change.

At operation 408, the language model outputs the series of actions to execute to the network administrator. For example, with reference to FIG. 1 the series of actions 1-N are presented to the network administrator 112 via the interface 114. In another example, with reference to FIG. 2 at (6) the series of optimal actions to implement the required configuration change are output to the network administrator 112. In some examples, the language models may automatically implement the series of optimal actions, or input the network administrator 112 for approval before automatically executing one or more actions. Whether to automatically implement actions may be customizable and tailored to a specific organizations need, or dependent on the severity or extent of a recommended change.

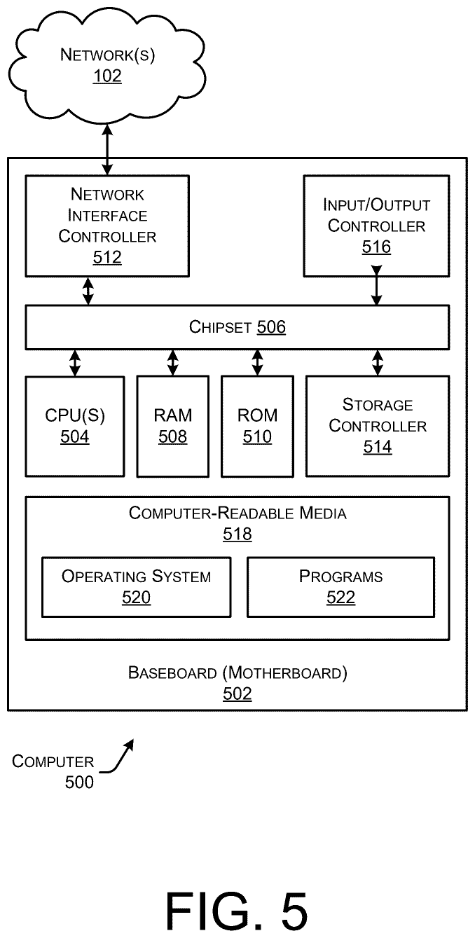

FIG. 5 shows an example computer architecture for a device capable of executing program components for implementing the functionality described above. The computer architecture shown in FIG. 5 illustrates any type of computer 500, such as a conventional server computer, workstation, desktop computer, laptop, tablet, network appliance, e-reader, smartphone, or other computing device, and can be utilized to execute any of the software components presented herein.

As described herein, the computer 500 may be any type of device, such as network controller 106 or network devices 108. Thus, the computer 500 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 500 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 500. The chipset 506 can further provide an interface to a computer-readable storage medium such as a read-only memory (“ROM”) 510 or non-volatile RAM (“NVRAM”) for storing basic routines that help to startup the computer 500 and to transfer information between the various components and devices. The ROM 510 or NVRAM can also store other software components necessary for the operation of the computer 500 in accordance with the configurations described herein.

The computer 500 can operate in a networked environment using logical connections to remote computing devices and computer systems through a network, such as the network 102. The chipset 506 can include functionality for providing network connectivity through a NIC 512, such as a gigabit Ethernet adapter. The NIC 512 is capable of connecting the computer 500 to other computing devices over the network 102. It should be appreciated that multiple NICs 512 can be present in the computer 500, connecting the computer to other types of networks and remote computer systems.

The computer 500 can be connected to a storage device 518 that provides non-volatile storage for the computer. The storage device 518 can store an operating system 520, programs 522, and data, which have been described in greater detail herein. The storage device 518 can be connected to the computer 500 through a storage controller 514 connected to the chipset 506. The storage device 518 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 500 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like.

For example, the computer 500 can store information to the storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 500 can further read information from the storage device 518 by detecting the physical states or characteristics of one or more particular locations within the physical storage units.

In addition to the mass storage device 518 described above, the computer 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 500. In some examples, the operations performed by the network controller 106, the network devices 108, the device(s) operated by the network administrators 112 with user interface 114, and or any components included therein, may be supported by one or more devices similar to computer 500. Stated otherwise, some or all of the operations performed by network controller 106, the network devices 108, and/or device(s) operated by the network administrators 112 having user interface 111, and or any components included therein, may be performed by one or more computer devices 500.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 518 can store an operating system 520 utilized to control the operation of the computer 500. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 518 can store other system or application programs and data utilized by the computer 500.

In one embodiment, the storage device 518 or other computer-readable storage media is encoded with computer-executable instructions which, when loaded into the computer 500, transform the computer from a general-purpose computing system into a special-purpose computer capable of implementing the embodiments described herein. These computer-executable instructions transform the computer 500 by specifying how the CPUs 504 transition between states, as described above. According to one embodiment, the computer 500 has access to computer-readable storage media storing computer-executable instructions which, when executed by the computer 500, perform the various processes described above with regard to FIGS. 1-4. The computer 500 can also include computer-readable storage media having instructions stored thereupon for performing any of the other computer-implemented operations described herein.

The computer 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device. It will be appreciated that the computer 500 might not include all of the components shown in the Figures, can include other components that are not explicitly shown in FIG. 5, or might utilize an architecture completely different than that shown in FIG. 5.

As described herein, the computer 500 may comprise one or more of the network controller 106, network devices 108 and/or any other device. The computer 500 may include one or more hardware processors 504 (processors) configured to execute one or more stored instructions. The processor(s) 504 may comprise one or more cores. Further, the computer 500 may include one or more network interfaces configured to provide communications between the computer 500 and other devices, such as the communications described herein as being performed by the network controller 106, the network devices 108 and/or the devices operated by the network administrators 112 with user interface 114. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 522 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for utilizing a language model to implement a configuration change in a network, the method comprising:
deploying the language model to a network controller that is configured to respond to inputs from network administrators associated with the network;
receiving, by the language model, an input from a network administrator indicating a description of a requirement for a configuration change;
determining, by the language model, a series of actions to execute to implement the configuration change; and
outputting, by the language model, the series of actions to execute to the network administrator.

2. The method of claim 1, wherein the language model is trained on network documentation and verbiage.

3. The method of claim 1, wherein the language model is a first language model and wherein determining the series of actions further comprises:
determining a series of subtasks for the configuration change;
inputting a description of each subtask into a second language model; and
receiving from the second language model an action to execute for each subtask.

4. The method of claim 3, wherein the second language model is fine-tuned with datasets that include one or more actions to execute for a description of a network configuration change.

5. The method of claim 3, wherein each subtask is input into the second language model multiple times and further comprising:
generating, by the second language model, multiple possible actions to execute to implement the subtask;
evaluating, by the second language model, each action of the multiple possible actions; and
determining, by the second language model, an optimal action to execute from the multiple possible actions.

6. The method of claim 5, wherein the optimal action is customizable and further based at least in part on policy requirements of an organization.

7. The method of claim 1, wherein the language model is a large language model (LLM).

8. A system comprising:
one or more processors; and
one or more computer-readable media storing computer-executable instructions that, when executed by the one or more processors, cause the one or more processors to perform operations comprising:
deploying a language model to a network controller that is configured to respond to inputs from network administrators associated with a network;
receiving, by the language model, an input from a network administrator indicating a description of a requirement for a configuration change;
determining, by the language model, a series of actions to execute to implement the configuration change; and
outputting, by the language model, the series of actions to execute to the network administrator.

9. The system of claim 8, wherein the language model is trained on network documentation and verbiage.

10. The system of claim 8, wherein the language model is a first language model and wherein determining the series of actions further comprises:
determining a series of subtasks for the configuration change;
inputting a description of each subtask into a second language model; and
receiving from the second language model an action to execute for each subtask.

11. The system of claim 10, wherein the second language model is fine-tuned with datasets that include one or more actions to execute for a description of a network configuration change.

12. The system of claim 10, wherein each subtask is input into the second language model multiple times and the operations further comprising:
generating, by the second language model, multiple possible actions to execute to implement the subtask;
evaluating, by the second language model, each action of the multiple possible actions; and
determining, by the second language model, an optimal action to execute from the multiple possible actions.

13. The system of claim 12, wherein the optimal action is customizable and further based at least in part on policy requirements of an organization.

14. The system of claim 8, wherein the language model is a large language model (LLM).

15. One or more non-transitory computer-readable media storing instructions that, when executed, cause one or more processors to perform operations comprising:
deploying a language model to a network controller that is configured to respond to inputs from network administrators associated with a network;
receiving, by the language model, an input from a network administrator indicating a description of a requirement for a configuration change;
determining, by the language model, a series of actions to execute to implement the configuration change; and
outputting, by the language model, the series of actions to execute to the network administrator.

16. The one or more non-transitory computer-readable media of claim 15, wherein the language model is trained on network documentation and verbiage.

17. The one or more non-transitory computer-readable media of claim 15, wherein the language model is a first language model and wherein determining the series of actions further comprises:
determining a series of subtasks for the configuration change;
inputting a description of each subtask into a second language model; and
receiving from the second language model an action to execute for each subtask.

18. The one or more non-transitory computer-readable media of claim 17, wherein the second language model is fine-tuned with datasets that include one or more actions to execute for a description of a network configuration change.

19. The one or more non-transitory computer-readable media of claim 17, wherein each subtask is input into the second language model multiple times and the operations further comprising:
generating, by the second language model, multiple possible actions to execute to implement the subtask;
evaluating, by the second language model, each action of the multiple possible actions; and
determining, by the second language model, an optimal action to execute from the multiple possible actions.

20. The one or more non-transitory computer-readable media of claim 19, wherein the optimal action is customizable and further based at least in part on policy requirements of an organization.
